(19) United States
(12) Patent Application Publication
(10) Pub. No.: US 2010/0098022 A1
(43) Pub. Date: Apr. 22, 2010

(54) METHOD AND APPARATUS FOR ROUTING A PACKET IN MOBILE IP SYSTEM

(76) Inventors: Csaba Keszei, Budapest (HU); Zoltan Turanyi, Szentendre (HU); Takatoshi Okagawa, Kanagawa (JP); Atsushi Iwasaki, Tokyo (JP)

Correspondence Address: ERICSSON INC., 6300 LEGACY DRIVE, M/S EVR 1-C-11, PLANO, TX, 75024, US

(21) Appl. No.: 12/376,938

(22) PCT Filed: Aug. 9, 2006
(86) PCT No.: PCT/JP2006/316071

§ 371 Date: Nov. 17, 2009

(51) Int. Cl. H04W 40/00; H04W 36/00; H04L 12/56

(52) U.S. Cl. 370/331; 370/329; 370/389

(57) ABSTRACT

The invention relates to a method, apparatus and system to preferably route a packet via an IP network, and more particularly to a routing entity having a buffer storing packets from/to a mobile entity. An initiation unit (500, 121) initiates a distribution of a routing topology change. A buffer unit (520) buffers a packet from/to the mobile entity (102) until the completion of the distribution. A release unit (502) releases the buffered packet after the completion.

### TECHNICAL FIELD

The invention relates to a method, an apparatus and a system to preferably route a packet via an IP network, and more particularly via a routing.

### BACKGROUND ART

The IP-based IMT network platform (IP² from now on) is a network architecture that supports terminal mobility with both route optimization and location privacy. Fundamental to IP² is the separation of the Network Control Platform (NCPF) and the IP Backbone (IP-BB) with the former controlling the latter. The IP-BB comprises IP routers with additional packet processing features, such as address switching. The NCPF comprise signaling servers that command the IP-BB entities intelligently.

Mobile terminals (or mobile nodes, MN) are assigned permanent terminal identifiers that take the form of an IP address. In addition MNs are assigned a routing address at the access router (AR) the mobile terminal is attached to. The routing address is specific to the location of the MN, hence to support location privacy the routing address shall not be revealed to other MNs. When the MN moves to another AR, a new routing address is allocated to the MN from the pool of routing addresses available at the new AR. The binding between the MN's terminal identifier (IPha, as of “IP home address”) and the MN's routing address (IPra, as of “IP routing address”) is communicated by the AR to the NCPF. More specifically the address is sent to the MN's visited routing manager (VRM) that manages the MN's movement in the visited network. The VRM, in turn informs the home routing manager (HRM) about the IPra of the visiting MN.

For instance, when a MN (MN1) wishes to send a packet to another MN (MN2), MN1 uses MN2's IPha as the destination address in the packet and transmits the packet to its AR (AR1). AR1 (identified as the sending AR) detects that the packet is addressed to an IP² MN and queries the NCPF, more specifically HRM of MN2 is queried about the IPra of MN2. The HRM responds and the IPra of MN2 is stored in AR1 along with the IPha of MN2. Then, the destination address of the packet (IPha of MN2) is replaced with the IPra of MN2 and the source address (IPha of MN1) is replaced with the IPra of MN1. This operation is referred to as address switching. The packet is then delivered using traditional IP forwarding to the node (AR2) that owns the IPra of MN2. AR2 (the receiving AR) then replaces the destination and source addresses of the packet back to the IPha of MN2 and MN1, respectively. Finally AR2 delivers the packet to MN2.

An important function of IP² is AR notification. Whenever MN2 moves to a new AR, the new AR allocates a new IPra for MN2 and the VRM is notified about this new IPra. Then the VRM updates the HRM, which, in turn, updates AR1. In fact, the HRM updates all ARs that have MNs that send packets to MN2. That is, when an AR queries the HRM about the IPra of MN1, the HRM stores the identity of the querying AR and when the IPra of MN1 changes the HRM updates all concerned ARs. We define this behavior as the AR being subscribed for updates of a particular IP² terminal identifier. Each query the AR makes about an IP² terminal identifier at the HRM results in the AR being subscribed at the given HRM for the given IP² terminal identifier.

To decrease the frequency of such updates, the VRM may configure an anchor (ANR) in the visited network of MN2. The ANR also allocates a routing address for MN1 that is then used by the VRM to update the HRM. Thus the IPra allocated by the ANR for MN2 is used by AR1 when MN1 sends packets to MN2. When these packets arrive to the ANR, the ANR replaces the destination address with the IPra allocated by AR2 for MN2. Then the packet is delivered further from the ANR to AR2 using traditional IP forwarding. AR2 switches the destination and source addresses back to the IPha of MN2 and delivers the packet to MN2 like if there was no ANR. Whenever a handover occurs, the VRM notifies the ANR of the new IPra allocated by the new AR for the MN. In contrast, the HRM is not notified because the IPra allocated by the ANR does not change. Hence, ARs that have MNs transmitting to MN2 also need not be notified of a handovers. The HRM (and consequently the ARs) is updated only when the ANR changes. This can happen intentionally due to path optimization or load balancing, or unintentionally when the current ANR fails and another is selected.

### DISCLOSURE OF INVENTION

The basic problem, which the invention provides a solution for, arises at handovers. At certain times the Routing Managers (VRM and HRM combined) need to configure multiple entities at the same time. If these updates happen in the wrong order, routing loops, incorrect routing or black holes may arise.

Since IP² is a very recent development, no solutions are published to the problems mentioned above. However, there are some related approaches.

From a routing point of view, mobility is a topology change. An entity with a fixed identifier (MN and its IPha) moves to a different part of the topology map. This topology change is then distributed among the network entities. The problem of this invention is the timing of the updates distribution. If certain nodes receive the information sooner than some others, then temporary inconsistencies may exist in the routing system. This may result in loops and/or unreachability.

Traditional IP routing protocols tackle topology changes differently. However, most of them are common in that the actual routing elements themselves do the controlling and the routing. In contrast, in IP² the decisions are made by the RMs and they control the routers remotely.

If a node moves, IP Distance Vector protocols simultaneously start distributing both the leave and the appearance of the node from the old and new attachment point, respectively. During the time these changes propagate to a potential source, packets may be looped or the destination node may be unreachable. The major tool to combat this timing is the propagation itself. Since the changes propagate from the place of the change outward, the more relevant (close) nodes get informed sooner. Although the propagation and its timing is not coordinated, it provide some protection. Routing loops may also arise temporarily due to an effect called counting to infinity that does not relate to the timing of the information. In addition, Distance Vector protocols using the DUAL algorithm (notably Enhanced Interior Gateway Routing Protocol: EIGRP) prevent counting to infinity and the consequently the infinite while promoting a longer unreachability. This is accomplished by being conservative towards the acceptance of new routes that may generate a loop.

Link state protocols (most notably Open Shortest Path First: OSPF) distribute topology changes and then calculate routing. Topology changes are also distributed in widening circles around the change in an uncoordinated manner. If topology changes reach certain nodes sooner than others, loops and routing failures (possibly unreachability) may occur. There are no known workarounds.

The above solutions handle timing problems at route changes only partially. Particularly in case of IP², routing updates need to be sent to multiple entities at the same time after a handover.
An IP Delete (IPD) is sent to the old AR of the moving MN.
An IP Update (IPU) is sent to the new AR of the moving MN.

Various race conditions may arise from a message being late. Late delivery may be the result of control message losses. In such cases no acknowledgement is received, the sender times out and retransmits the message. However, this may result in significant delays in delivering the message.

If the IPU to the new AR (nAR) is late, packets may arrive to the MN's new routing address without the nAR knowing what to do with the packets. Moreover, packets addressed to its peers may arrive from the MN. The nAR will not know the corresponding routing address will not forward the packets. Although the emission of such packets can be prevented by withholding the handover completion notification (Activate Acknowledgement) from the MN, it might occur when a MN is not fully compliant.

The present invention describes a method, an apparatus and a system to preferably route a packet from the mobile entity comprising the steps of initiating the distribution of a routing topology change, buffering a packet from/to the mobile entity until the completion of the distribution, and releasing the packet buffered after the distribution completion.

Accordingly, embedding a buffer unit and a release unit to a routing entity enables to solve the race condition when a mobile entity handovers from another routing entity. The buffer unit buffers a packet addressed to a routing address allocated to the mobile entity and/or a packet from the mobile entity to a correspondent entity until a response is received from the mobility manager of the mobile entity. The release unit releases the packet after the response is received.

Furthermore, downlink packets arriving to the new AR before the response arrives from the mobility manager can be forwarded to the MN since all necessary information is available in the new AR. This early forwarding solves the race condition since it forwards the packet without waiting for a response from the mobility manager.

In the original IP² all user data packets arriving before the response from the mobility manager are dropped.

Other features and advantages of the present invention will be apparent from the following descriptions taken in conjunction with the accompanying drawings, in which like reference characters designate the same or similar parts throughout the figures thereof.

### BRIEF DESCRIPTION OF DRAWINGS

The following detailed descriptions offer a thoroughly overview of the method, apparatus and system when taken in conjunction with the accompanying drawings wherein:

FIG. 1 shows an overview of an exemplary mobile communication system to which the present invention is preferably applied;

FIG. 2 shows an exemplary signal sequence of the embodiment;

FIG. 3 shows an exemplary signal sequence of another embodiment;

FIG. 4 shows an exemplary signal sequence of another embodiment;

FIG. 5 shows an exemplary block diagram illustrating basic components of the access router in the preferred embodiments; and

FIG. 6 shows a flowchart illustrating a routing process on the exemplary embodiments.

### BEST MODE FOR CARRYING OUT THE INVENTION

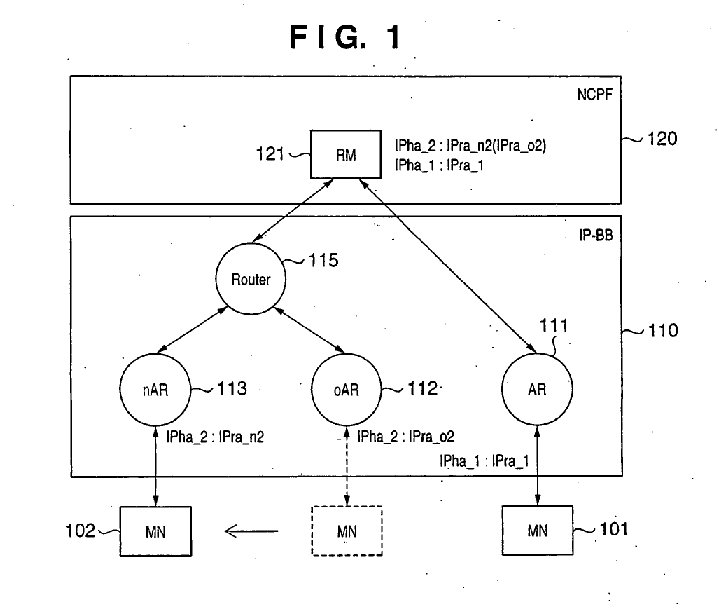

FIG. 1 is an overview of an exemplary mobile communication system to which the present invention is preferably applied. In FIG. 1, 101 denotes an exemplary Mobile Node (MN). MN 101 is a correspondent node communicating with another node (MN) 102 via Access Router (AR) 111. MN 101 can either be a fixed node. In the presented scenario, MN 102 is an exemplary mobile node which handovers from an old Access Router (oAR) 112 to a new Access Router (nAR) 113. The MN may be a mobile terminal in a mobile telecommunication network compliant with 3G or higher generation standards.

The Router 115 is a normal router. According to the IP-based IMT network Platform (IP²), the network is separated in two, namely the Network Control Platform (NCPF) 120 and the IP Backbone (IP-BB) 100. The NCPF controls packet routing in the IP-BB 100. RM 121 is an exemplary manager entity, which manages the mobility of the mobile entity, such as MN 102. As mentioned above, RM function 121 may be implemented in separate nodes, namely the Visited Routing Manager (VRM) and the Home Routing Manager (HRM).

In this scenario, the oAR 112 allocates a routing address such as IP Routing Address (IPra) to the MN 102. The oAR 112 maintains a source address table and a destination address table. The source address table keeps a relation between IPha and IPra of MN 102. The destination address table keeps a relation between IPha and IPra of MN 101 as a communication peer of MN 102. These tables are updated according to the IP Update/IP Delete command sent from RM 121.

Before a handover, MN 101 uses MN 102's IPha as the destination address in the packet and transmits the packet to AR111. AR 111 detects that the packet is addressed to an IP²MN and queries the RM 121 about the IPra of MN 102. RM 121 responds and the IPra of MN 102 (IPra_o2 is stored in AR 111 along with the IPha of MN 102 (IPha_2). AR 111 replaces the destination address of the packet (IPha_2) to the IPra of MN 102 (IPra_o2) based on the destination address table. Also AR111 replaces the source address (IPha of MN 101: IPha_1) to the IPra of MN 101 (IPra_1) based on the source address table.

The packet is then delivered using IP forwarding to the AR 112 that owns the IPra of MN 102. AR 112 then replaces the destination and source addresses of the packet back to the IPha of MN 102 and MN 101, respectively. Finally AR 112 delivers the packet to MN 102.

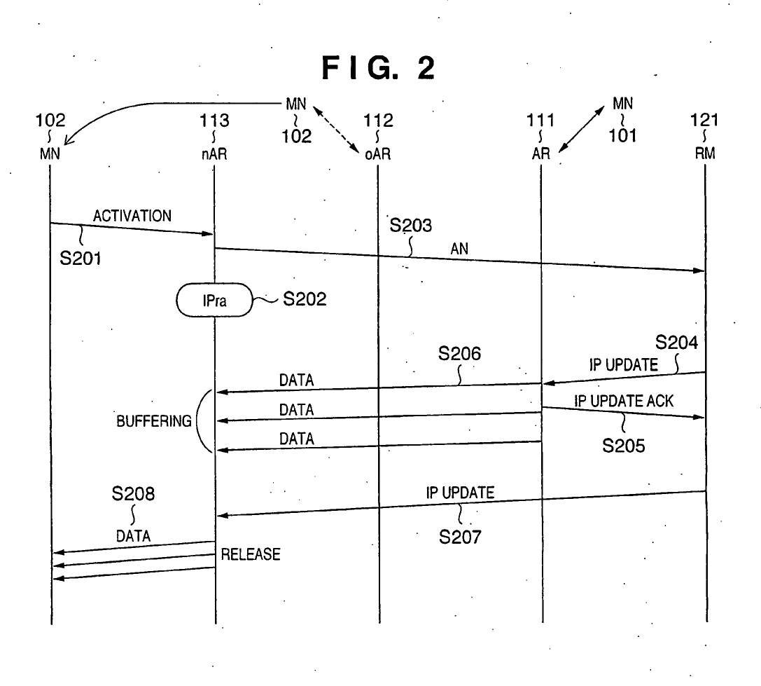

FIG. 2 shows an exemplary signal sequence of the embodiment. In this scenario, MN 102 has moved to a service area of nAR 113 from a service area of oAR 112.

Beginning at step S201, MN 102 executes an activation process with nAR 113. IPha of MN 102 (IPha_2) is informed nAR 113 through the activation process. At step S202, nAR 113 allocates a new IPra (IPra_n2) from the address pool and stores the IPra_n2 and the IPha_2 in a temporary table. The temporary table is neither the destination address table nor the source address table. At step S203, nAR 113 sends an Activation Notification (AN) with IPha of MN 102 to RM 121. RM 121 updates the binding between IPha and IPra of MN 102. At step S204 and S207, RM 121 sends the IP Update (IPU) command to ARs (at least AR 111 and AR113). Although it is not shown in FIG. 2, RM 121 sends to oAR 112 an IP Delete (IPD) command. These actions are exemplary steps for initiating the distribution of a routing topology change.

At step S205, AR111 and other ARs receive the IPU command and update their address tables accordingly. After the update, AR 111 and the other updated ARs send back an IP Update Acknowledgement (IPU Ack) to RM 121.

Note that AR111 is updated sooner than nAR 113 in this scenario. This fact results that AR111 starts routing packets from MN101 to the new IPra (IPra_n2) of MN 102 at step S206, even though nAR 113 has not updated its destination address table yet. Thus, at step S206, nAR 113 stores the unknown destination packets from MN 101 into a buffer unit, since the destination address table cannot resolve the address.

At step S207, nAR 113 waits to receive the IP Update command from RM 121. If received, nAR 113 releases the packets stored in the buffer unit, and send the packets to MN 102 at step S208.

According to the preferred embodiment, a simple but very effective solution is provided to reduce the race condition. Indeed, the routing entities, such as access routers, buffer packets destined to the mobile entity until the completion of the topology change's distribution, and release the buffered packets once completed. Therefore, a race condition emerging from unconformities in address table updates among ARs can be avoided. In other words, significant packet losses are avoided.

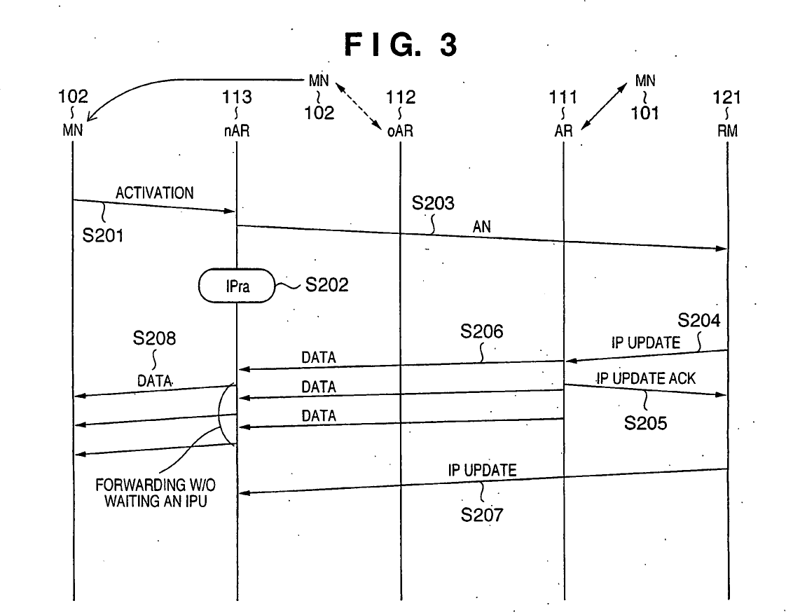

FIG. 3 shows an exemplary signal sequence of another embodiment. In this scenario, AR111 sends packets from MN 101 to MN102 before nAR 113 receives the IPU command as a response.

In this alternative embodiment, nAR 113 forwards the packets to MN102 without waiting for an IPU command at step S308. The nAR 113 can forward the packets since it maintains all necessary information (IPra, IPha of MN 102 and Layer 2 connectivity parameters for MN 102, e.g. MAC address). The necessary information is stored in a temporary table. Although this approach requires the installation of a route without receiving a response (e.g. IPU command) from the RM, there are some advantages that it does not require a buffer and release unit.

According to this alternative embodiment, a simple but very effective solution is provided in order to reduce the race condition. Indeed, the routing entity, such as the access router, comprises a forwarding unit, which forwards packets addressed to the routing address (e.g. IPra_n2) of the mobile entity (e.g. MN 102) without waiting for a response (e.g. IPU command) from the mobility manager (e.g. RM 121) or the completion of the distribution of the topology change. Therefore, any race condition emerging from unconformities in address table updates among ARs can be avoided. In other words significant packet losses are avoided.

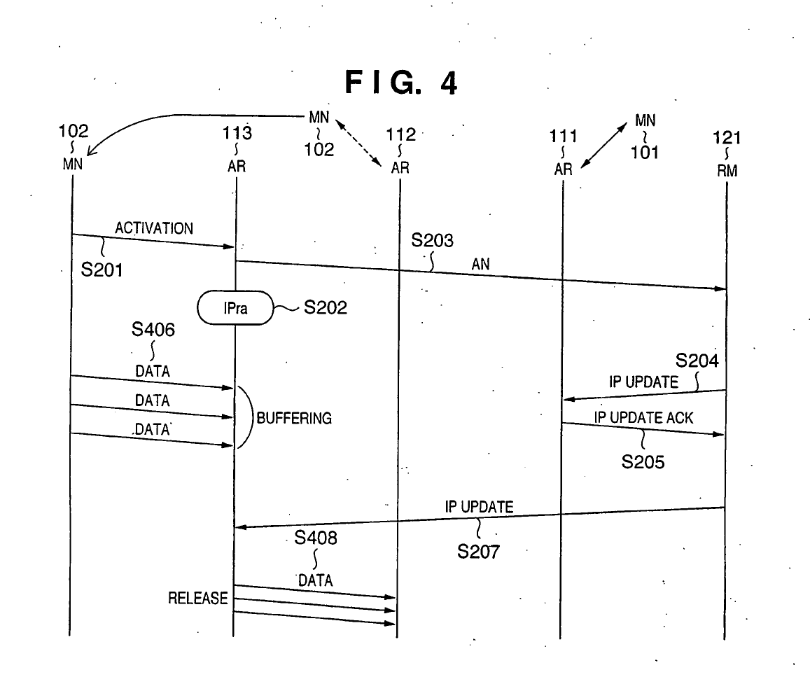

FIG. 4 shows an exemplary signal sequence of another embodiment. In this scenario, MN 102 sends packets to corresponding entities (e.g. MN 101) before nAR 113 receives the IPU command.

After notifying the arrival of MN 102, nAR 113 receives packets from MN 102. Although the packets from MN 102 have the new IPra (IPra_n2) allocated by nAR 113, the destination address table has not been updated yet. Without an update of the table, nAR 113 cannot route the packets. Thus nAR 113 stores the packets from MN 012 in a buffer unit until nAR 113 receives the IPU command sent from RM 121 at step S406.

When nAR 113 receives the IPU command, it releases the packets from the buffer unit.

Accordingly, a simple but very effective solution is provided to reduce race conditions. Indeed, the routing entities such as access routers buffer packets from the mobile entities until completion of the distribution of the topology change, and release the buffered packets after the completion. Therefore, a possible race condition originating from unconformities in address table updates among ARs can be avoided. In other words significant packet losses are avoided.

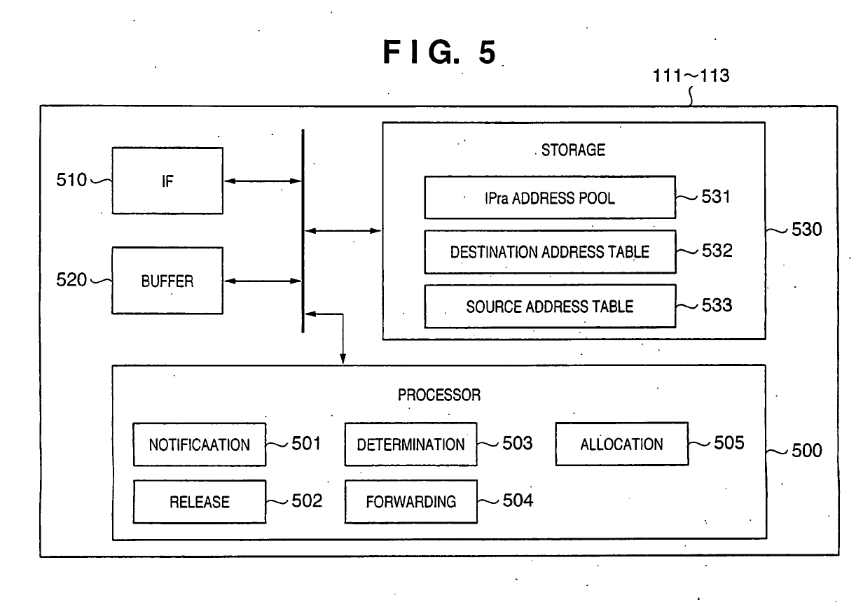

FIG. 5 is an exemplary block diagram illustrating basic components of the access router in the preferred embodiments. In the Figure, a processor unit 500 is the main unit of the AR and can be configured with logic circuits and/or a CPU with computer programs. The processor unit 500 comprises a notification unit 501, a release unit 502, a determination unit 503 a forwarding unit 504 (as option) and an allocation unit 505.

The notification unit 501 notifies RM 121 of the MN's arrival through the activation notification. The release unit 502 controls a packet release process for the buffer unit 520. The determination unit 503 determines whether the IPU command from RM121 has been received or not. The forwarding unit 504, which is an optional function, forwards a packet received from MN 102 without waiting for the IPU command from RM 121. The allocation unit 505 allocates a new IPra to a MN which handovers from another AR (oAR).

The IF unit 510 is an IP packet sending/receiving circuit. The buffer unit 520 temporary stores a packet addressed to a new IPra allocated to MN 102 and/or a packet from MN 102 to a correspondent entity MN 101 until the IPU command is received from RM121.

The storage unit 530 stores the IPra address pool 531, the destination address table 532 and the source address table 533. The storage unit 530 can either be a flash memory, a RAM and/or a hard disk drive.

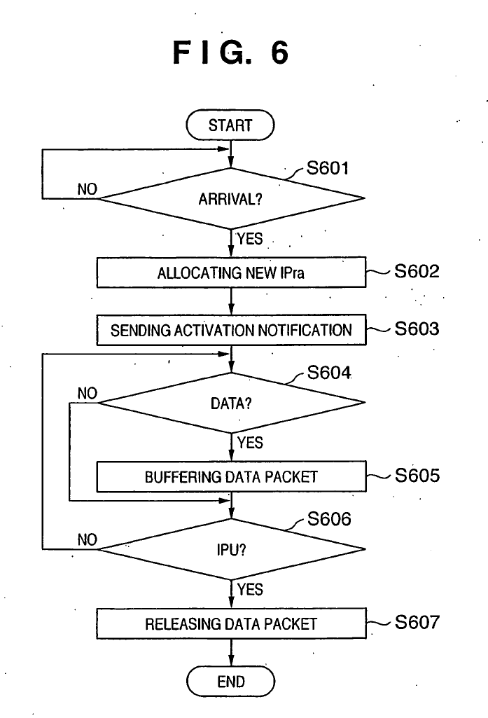

FIG. 6 is a flowchart illustrating a routing process on the exemplary embodiments. At step S601, the processor unit 500 determines whether a new MN has arrived or not. In case of arrival, the process goes on to the next step. If not, the processor unit 500 waits for an arrival.

At step S602, the allocation unit 505 of the processor unit 500 allocates a new IPra (IPra_n2) to the arriving MN 102. At step S603, the notification unit 501 sends the activation notification to RM 121.

At step S604, the processor unit 500 determines whether the packet addressed to the IPra (IPra_n2) allocating the new MN (MN 102) address has been received or not. In addition to or upon this determination, the processor unit 500 may determine whether the packet from the new MN destined to a correspondent entity (MN 101) has been received or not. If the packet has been received, the process reaches step S605. If not, the process reaches step S606.

At step S605, the buffer unit temporarily stores the received packet(s). At step S606, the determination unit 503 determines whether the IPU command has been received from RM 121 corresponding to the activation notification sent at step S603. If the IPU command has been received, the process reaches step S607. If not, the process reaches step S604.

At step S607, the release unit releases the packet(s) from the buffer unit 520 to an appropriate entity (MN 102 or MN 101 via the AR).

Note that processor unit 500 updates the destination address table 532 and the source address table 533 according to the IPU command received from RM 121. After the table update, the packets from/to MN 102 are routed in the normal IP² manner.

Although several embodiments of the method, apparatus and system of the present invention have been illustrated in the accompanying drawings and described in the foregoing description, it shall be understood that the invention is not limited to the embodiments disclosed, but is capable of numerous rearrangements, modifications and substitutions without diverging from the spirit of the invention as set forth and defined by the following claims.

1-30. (canceled)

31. A routing entity used in a communication system, the communication system including a mobile entity having a home address, a plurality of routing entities routing packets from and to the mobile entity, and a mobility manager managing the mobility of the mobile entity, the routing entity comprising:
an allocation unit for allocating a routing address to the mobile entity when the mobile entity hands over from another routing entity to the routing entity;
a storing unit for storing a temporary table maintaining the routing address allocated to the mobile entity;
a notification unit for notifying the mobility manager of the allocated routing address and the home address so that the mobility manager requests routing entities which involves the routing of packets addressed to the routing address of the mobile entity, to change their routing tables regarding the mobile entity, receives acknowledge from the involving routing entities and sends a response to the routing entity; and
a forwarding unit for forwarding the packets addressed to the routing address of the mobile entity based on the temporary table before the routing entity receives the response from the mobility manager and updates a main routing table.

32. The routing entity of claim 31, wherein the update triggers the update of an address table, and the address table stores the home addresses and the routing addresses.

33. The routing entity of claim 31, wherein both of the home addresses and the routing addresses are IP addresses.

34. The routing entity of claim 31, wherein the mobile entity is a mobile terminal in a mobile telecommunication network.

35. The routing entity of claim 31, wherein the mobility manager is a routing manager of the IP based IMT network platform.

36. A communication system including a mobile entity having a home address, a plurality of routing entities routing packets from and to the mobile entity and a mobility manager managing the mobility of a mobile entity,
each of the routing entities comprising:
an allocation unit for allocating a routing address to the mobile entity when the mobile entity handovers from another routing entity to the routing entity;
a storing unit for storing a temporary table maintaining the routing address allocated to the mobile entity;
a notification unit for notifying the mobility manager of the allocated routing address and the home address so that the mobility manager requests routing entities which involves the routing of packets addressed to the routing address of the mobile entity, to change their routing tables regarding the mobile entity, receives acknowledge from the involving routing entities and sends a response to the routing entity; and
a forwarding unit for forwarding the packets addressed to the routing address of the mobile entity based on the temporary table before the each of the routing entities receives the response from the mobility manager and updates a main routing table.

37. The communication system of claim 36, wherein an address table is updated by the update triggers, and the address table stores the home addresses and the routing addresses.

38. The communication system of claim 36, wherein both of the home addresses and the routing addresses are IP addresses.

39. The communication system of claim 36, wherein the mobile entity is a mobile terminal in a mobile telecommunication network.

40. The communication system of claim 36, wherein the mobility manager is a routing manager of the IP based IMT network platform.

41. A method for routing a packet in a communication system comprising a mobile entity having a home address, a routing entity in a plurality of routing entities routing a packet from and to the mobile entity, and a mobility manager managing the mobility of the mobile entity, the method comprising the steps of:
allocating a routing address to the mobile entity when the mobile entity hands over from another routing entity to the routing entity;
storing a temporary table maintaining the routing address allocated to the mobile entity;
notifying the mobility manager of the allocated routing address and the home address so that the mobility manager requests the another routing entity which involves the routing of packets addressed to the routing address of the mobile entity, to change their routing tables regarding the mobile entity, receives acknowledge from the another routing entity and sends a response to the routing entity; and
forwarding the packets addressed to the routing address of the mobile entity based on the temporary table before the routing entity receives the response from the mobility manager and updates a main routing table.

42. The method of claim 41, wherein the update triggers the update of an address table, and the table stores the home addresses and the routing addresses.

43. The method of claim 41, wherein both the home addresses and the routing addresses are IP addresses.

44. The method of claim 41, wherein the mobile entity is a mobile terminal in a mobile telecommunication network.

45. The method claimed in claim 41, wherein the mobility manager is a routing manager of the IP based IMT network platform.
